(19) United States
(12) Patent Application Publication
(10) Pub. No.: US 2025/0160263 A1
(43) Pub. Date: May 22, 2025

(54) DEVICE FOR ADMINISTERING A DOSE OF UV LIGHT IN TWO SECONDS OR LESS AND ASSOCIATED METHODS AND USES

(71) Applicants: UV BOOSTING SAS, Boulogne Billancourt (FR); Avignon Université, Avignon (FR)

(72) Inventors: Laurent URBAN, Mollégès (FR); Jawad AARROUF, Le Pontet (FR); Yves MATTON, Vanves (FR); Loïc LEDERMANN, Saint Germain en Laye (FR); Hugo GONCALVES, Poissy (FR)

(73) Assignees: UV BOOSTING SAS, Boulogne Billancourt (FR); Avignon Université, Avignon (FR)

(21) Appl. No.: 19/030,340

(22) Filed: Jan. 17, 2025

Related U.S. Application Data
(63) Continuation of application No. 17/627,985, filed on Jan. 18, 2022.

(51) Int. Cl. A01G 7/04; A01G 9/24; A01G 22/05; A01G 22/25; A01G 22/35; A01G 22/45

(52) U.S. Cl. CPC A01G 7/045; A01G 9/249; A01G 22/05; A01G 22/25; A01G 22/35; A01G 22/45

(57) ABSTRACT

A plurality of apparatus herein includes a locomotion device, a storage space with straps configured to be carried on a user's back, a trolley, or a wheelbarrow that each have a reflector body extending therefrom to which is mounted a UV-C light source operatively positioned relative to a reflector and operatively temperature controlled by an on-board temperature control unit to form a panel. The UV-C light source is operatively controlled to administer a dose of UV-C light based on a duration of exposure of at most two seconds when the panel has an optical power density between 300 W/m² and 3000 W/m² and a surface area of 0.01 m² to 5 m². The dose is in a range of 100 J/m² to 1600 J/m² as the locomotion device moves at an operating speed in a range of 1 km/hr to 10 km/hour.

### CROSS-REFERENCE TO RELATED APPLICATIONS

This application is a continuation of U.S. application Ser. No. 17/627,985, filed Jan. 18, 2022, which was filed under 35 U.S.C. § 371 as the U.S. national phase of International Patent Application No. PCT/EP2020/069480, filed Jul. 10, 2020, which designated the United States and which claims the benefit of French Patent Application No. 1908196 filed Jul. 19, 2019, which is hereby incorporated in its entirety including all tables, figures, and claims.

The following invention is a device for administering a dose of UV light in two seconds or less and associated methods and uses. One such use is relevant to the field of agronomy. It specifically relates to a mobile light exposure device for improving the yield and quality of biological, particularly plant, material, as well as to the process and associated uses.

Improving crop yields and the quality of the biological material produced is an important current issue in the development of sustainable and environmentally friendly agriculture.

Even today, the use of phytopharmaceutical products remains the most effective solution for optimising crop yields.

Phytopharmaceutical products are any substances or formulations used to prevent, destroy or repel organisms undesirable to agriculture or public health, to stimulate plant metabolism, growth or morphogenesis. The most commonly used types of phytopharmaceutical products are pesticides, hormones and growth enhancers. A phytopharmaceutical product often takes the form of a chemical substance with or without additives.

The use of these substances is often recommended for large-scale cultivation such as in fields or greenhouses, as well as in public green areas and private gardens. As it is, crops are more difficult to control due to the presence of many biotic and abiotic factors that can affect the growth and, in the case of agricultural production, the final quality of the plants at harvest.

The harmful effects of phytopharmaceutical products on the environment and the contamination of drinking water resources such as groundwater have been taken into consideration.

Many animal species such as birds or non-pest insects (e.g. pollinators) are affected by phytopharmaceutical products. A direct poisoning can occur due to the presence of residues of phytopharmaceutical products, especially when animals enter treated fields.

Runoff from phytopharmaceutical products can also affect aquatic fauna, leading to the death or reduction of fish and amphibian populations. This fatality can be direct or indirect. Repeated exposure to phytopharmaceutical products can cause physiological and behavioural changes, but can also lead to decomposition of the plants, thus depriving fish of oxygen.

The consumption of products or by-products from agriculture using phytopharmaceutical products is the subject of numerous studies to determine the effects on health in the medium and long term.

The WHO also warns of the direct and indirect hazards to humans from the use of and exposure to phytopharmaceutical products, which can manifest themselves as acute poisoning or chronic side-effects.

Exposure to phytopharmaceutical products is also suspected of being the cause of numerous disorders and pathologies such as cognitive disorders; anxiety-depressive disorders; disorders of child development during pregnancy; fertility problems; problems of metabolisation of phytopharmaceutical products; metabolic problems (obesity, type II diabetes, thyroid dysfunction, . . . ); various cancers such as leukaemia, testicular cancer, brain tumours, melanoma, Hodgkin's disease, Kahler's disease; Parkinson's disease; Alzheimer's disease; and amyotrophic lateral sclerosis.

In view of the above, there is now a need to develop and optimise alternative techniques that achieve results that are substantially as effective as with the conventional use of phytopharmaceutical products but less harmful to health and the environment. Therefore, the Applicant was interested in plant treatments without the use of phytopharmaceutical products. Among these treatments, the treatment of crops with light appears to be an interesting and promising avenue.

### Prior Art

Light treatment of crops is an interesting alternative to overcome these problems and does not have the negative environmental and health effects of phytopharmaceutical products described above.

Light is one of the most important environmental factors regulating plant growth and development. Plants need light not only for photosynthesis, but also for precise regulation of their development.

Several abiotic factors can influence plant metabolism and vigour, such as lack of water, excessive temperatures or ultraviolet radiation.

Ultraviolet (UV) radiation, also known as “black light” because it is not visible to the naked eye, is electromagnetic radiation of shorter wavelength than visible light but longer than X-rays. They can only be observed indirectly, either by fluorescence or with the help of specialised detectors.

Ultraviolet, blue and red radiation are involved in various photomorphogenic responses. UV-B wavelengths (280-315 nm) are biologically active and when applied at non-harmful doses induce changes in gene expression, physiology, metabolite accumulation and plant morphology.

As with other components of the solar spectrum, the effects of UV-B on plant physiology are influenced by hormones. Some of these hormones, such as abscisic acid, jasmonic acid, salicylic acid and ethylene, appear to be mainly factors of adaptation to environmental variations and stress. Other hormonal pathways using gibberellins and auxins in particular confer mainly morphological changes.

The use of UV-B radiation therefore influences the metabolism of plants to act on their morphology and in particular allows the synthesis of molecules such as flavonoids or the accumulation of phenolic pigments such as anthocyanins.

However, there are practical problems when using UV-B. Prolonged exposure of several hours or even days is required to be effective. However, prolonged exposure is difficult to implement on crops outside greenhouses.

UV-C radiation, on the other hand, is sufficiently energetic to break chemical bonds. Absorption at particular wavelengths can be associated with resonance effects in which certain energy levels in an atom or molecule are almost equalled by the energies of incident photons. Used in high doses, UV-C can therefore cause direct damage to various molecules (nucleic acids, proteins, etc.).

With this in mind, UV-C radiation is commonly used for surface disinfection purposes.

Once the cuticular barrier is crossed in plants, UV-C radiation is more strongly absorbed than UV-B or UV-A. This is due to the fact that UV-C radiation excites many more molecules than UV-B and UV-A radiation, which are only absorbed by highly complex compounds or those with C═O or C+N functions, for example. Since it is absorbed more strongly than UV-B and UV-A, UV-C radiation is much less likely to penetrate deep into the tissue and thus cause damage, particularly on DNA molecules.

As UV-C is safer for the treated plants than UV-B or UV-A, it has been tested on different types of plant organs with the idea of identifying hormetic doses, i.e. doses that produce positive biological effects.

Earlier patent documents disclose the use of UV, in particular UV-C, on plants, but for different purposes than the invention in question.

Document WO9533374 details the use of a laterally moving rail vehicle to emit a glow discharge consisting of a mixture of UV-A, B, C, visible and infrared light. The exposure time of the plants to this light discharge is less than ten seconds, preferably three seconds. The use of this device is intended for the destruction of unwanted plants. As such, this paper discourages the use of radiation, particularly UV-C, to improve the yield and quality of biological material.

Document WO2007/049962 describes the use of a transport means for conveying plants under a light source consisting of at least 90% UV-C. This device is used for plant or fungus treatment purposes to control the growth of pathogens, insect pests and also for the destruction of aerial plant parts. As such, this paper does not consider the use of light pulses to improve the yield and quality of biological material.

Document FR3063974 describes a device with a conveyor belt for direct exposure of harvested plants to UV-C light pulses to decontaminate their surface which is contaminated with phytopharmaceutical products. However, this document does not describe a mobile device comprising locomotion means for moving the device, nor does it describe the use of the device to improve the yield and quality of biological material.

Finally, document DE19900616Al describes a method for stimulating the production of anthocyanins in plants and fruits using a device emitting light at wavelengths in the visible spectrum but also UV-A and UV-B. However, the method described does not mention the use of UV-C for the improvement of the yield and quality of biological material, nor an exposure time of the order of seconds.

### Technical Problems

Taking the above into account, one problem that this invention proposes to solve consists in developing an alternative device that makes it possible to dispense with, or at least greatly limit, the use of phytopharmaceutical products. This alternative must ensure sufficient yield and quality of biological material.

Moreover, this device must be more ecological in order to preserve the environment, but also simple to use.

Its applications must be feasible at different scales, both in the greenhouse and in the field.

### Technical Solution

The first goal of the solution to this problem is a mobile light exposure device for improving the yield and quality of biological material comprising:
one module for emitting one or more light pulses, comprising at least one light treatment panel with a surface area of between 0.01 m² and 10 m²;
another module for adjusting, remotely or on the device, the optical power density of the treatment panel and possibly the temperature of said panel;
a means of locomotion for moving the device, preferably at a speed of between 1 and 10 km/h;
   wherein the optical power density of the panel is between 100 W/m² and 10,000 W/m², preferably between 300 W/m² and 3,000 W/m², and wherein the light pulses delivered to the said biological material are of identical or different wavelengths and/or durations but less than or equal to two seconds, preferably less than or equal to one second.

In particular, the Applicant has been able to demonstrate that UV-C radiation is less harmful than UV-B or UV-A radiation in plants. UV-C radiation is less penetrative to the tissue due to the micro-relief of epicuticular wax crystals that cause it to scatter on the leaf surface. After crossing the epicuticular barrier, penetration is all the lower as there is a high molecular uptake in the plant cells under the cuticle.

With this in mind, the idea of using the more energetic UV-C instead of UV-B for much shorter periods of time therefore appears to be more advantageous to the Applicant.

A second objective for the invention is a process for improving the yield and quality of biological materials comprising the following steps:
installation of a device according to the invention on a farm comprising plantations to be treated;
passage of said device through the plantations, combined with direct exposure of the biological material to light pulses of the same or different wavelengths and/or durations, wherein the wavelengths are the same or different and are between 200 nm and 700 nm (UV-C, UV-B, UV-A, visible light), preferably between 200-280 nm (UV-C);
   and wherein the exposure times are the same or different but less than or equal to two seconds, preferably less than or equal to one second.

Finally, the third objective is the use of a device according to the invention for modifying the physiology of a biological material.

### Benefits Provided

The invention developed consists of a mobile light pulse emitting device with qualities of adaptability and ease of regular use for the treatment of surfaces of variable size.

The applicant has been able to demonstrate that UV-B induced changes include:
an effect on morphology (organ size, plant architecture, vegetative and reproductive development speed, etc.),
changes in primary (proteins, lipids, carbohydrates, etc.) and secondary (phenolic compounds, alkaloids, terpenoids, glucosinolates, cannabinoids, etc.) metabolisms,
improved performance.

These same changes can be observed using UV-C radiation with shorter exposure times when used at a given power and do not a priori cause negative effects on plants. They are perceived by plants and stimulate signalling and metabolic pathways influencing growth, development, branching, flowering, yield and quality under both normal and stress conditions. Applied at hormetic doses, i.e., doses that allow positive biological effects to be obtained, without negative side effects, they can be used in the field of agronomy to improve the yield and quality of biological material in order to obtain improved commercial products, particularly in terms of their concentrations of compounds of interest.

### BRIEF DESCRIPTION OF THE DRAWINGS

The invention and the advantages thereof will be better understood on reading the following description and non-limiting embodiments, illustrated with reference to the annexed drawings in which:

FIG. 1 illustrates a front view of a device according to the invention which is a mobile light exposure module 1 comprising a first double-sided light pulse emitting module 3 held by a straddling device 5 mounted on a tractor 4.

FIG. 2 shows a front view of the device according to the invention which is a mobile light exposure module 1 comprising a first single-sided light pulse emitting module 3 held by an inter-row structure 5 mounted on a tractor 4.

FIG. 3A illustrates in profile view the device according to the invention which is a mobile light exposure module 1 comprising a first light pulse emission module 3 held by a mechanical adjustment module 8 mounted on a tractor 4 for low crops. Said mobile light exposure module 1 also includes a module 6 for adjusting the optical power density of the treatment panel and the temperature, as well as an independent and/or autonomous power source 7.

FIG. 3B shows a front view of a device according to the invention which is a mobile light exposure module 1 for a greenhouse suitable for tall crops such as tomatoes.

FIG. 3C shows a front view of a device according to the invention which is a mobile greenhouse light exposure module 1 suitable for low growing cannabis crops.

FIG. 4 shows, in front view, an example of a possible structure of a reflector body 9 of a device according to the invention comprising at least a light source 10, reflectors 11 and a temperature control unit 12.

FIG. 5 shows, in profile view, the composition of an example of a reflector body 9 of a device according to the invention comprising the temperature control block 12 and a set of temperature and light output sensors 13.

FIG. 6 is a graph associated with Example 2 showing the effects of different doses of UV-C on a mass of leek barrels. Different letters in the figure indicate the existence of significant differences at the 5% level (Tukey test).

FIG. 7 is a graph associated with Example 2 showing the effects of different doses of UV-C on the length of leek barrels. Different letters in the figure indicate the existence of significant differences at the 5% level (Tukey test).

FIG. 8 is a graph associated with Example 4 showing the effects of different doses of UV-C on the amount of phenols in carrot root tubers. Different letters in the figure indicate the existence of significant differences at the 5% level (Kruskal-Wallis test).

FIG. 9 is a graph associated with Example 4 showing the effects of different doses of UV-C on the amount of flavonoids in carrot root tubers. Different letters in the figure indicate the existence of significant differences at the 5% level (Kruskal-Wallis test).

FIG. 10 is a graph associated with Example 4 showing the effects of different doses of UV-C on the % anti-radical activity in carrot root tubers. Different letters in the figure indicate the existence of significant differences at the 5% level (Kruskal-Wallis test).

FIG. 11 is a graph associated with example 5 which illustrates the total sum of flowers formed as a function of UV-C, Vacciplant® and UV-C plus Vacciplant® treatments in the strawberry ‘Gariguette’ over time.

FIG. 12 is a graph associated with example 5 which illustrates the percentage of plants in flower as a function of UV-C, Vacciplant® and UV-C plus Vacciplant® treatments in ‘Gariguette’ strawberry over time.

FIG. 13 is a graph associated with Example 6 showing the effects of two doses of UV-C on the number of green fruits in ‘Gariguette’ strawberry, 8 weeks after planting.

### DESCRIPTION OF THE METHODS OF IMPLEMENTATION

In this description, unless otherwise specified, it is understood that when an interval is given, it includes the upper and lower bounds of the interval.

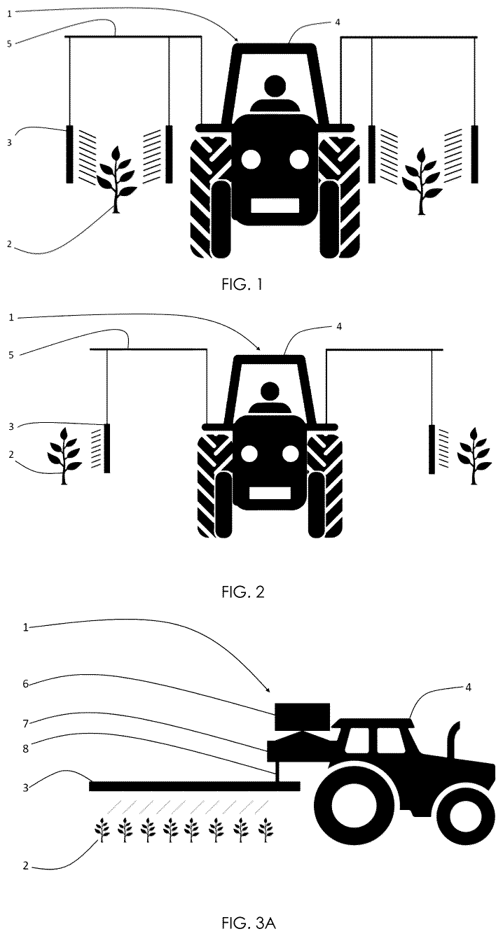

According to the invention, the mobile light exposure device 1 for improving the yield and quality of biological material 2 as illustrated in FIGS. 1 to 3 comprises a first module for emitting one or more light pulses 3.

By light exposure, the applicant means one or more light sources 9 from said device emitting at wavelengths between 200 nm and 700 nm.

The first module of the mobile light exposure device 1, comprising one or more discharge lamps according to the invention, allows one or more light pulses to be emitted. Non-limiting examples of lamps that can be used are low, medium or high pressure lamps, pulsed light or Xenon lamps, Excimer lamps, LED lamps or mercury vapour lamps (254 nm).

The light pulses are characterised in particular by their duration and wavelength.

The durations of the light pulses are necessarily less than two seconds, preferably less than or equal to one second.

Preferably, the duration of the light pulses is between one second and one thousandth of a second. Preferably, it is between one second and one hundredth of a second. Particularly preferred values used by the Applicant are one second, one tenth of a second, one hundredth of a second or 300 μs or 500 μs.

The number and frequency of the light pulses are modulated according to the nature of the biological material to be treated 2.

The wavelengths of the light pulses are generally between 200 nm and 700 nm (UV-C, UV-B, UV-A, visible light), preferably between 200 and 280 nm (UV-C). Even more advantageously, they are between 250 and 265 nm.

Even more preferably, the light pulses can be:
flashes of pulsed light with a wavelength between 200 nm and 700 nm with a duration of a few hundred microseconds (e.g. 300 μs to 500 μs) and
UV-C flashes which are advantageously 1 to 2 second flashes.

The device according to the invention allows the improvement of the yield and quality of the biological material 2.

Biological material 2 means plant material, fungus or microorganisms or media from the culture of microorganisms. Preferably, the biological material 2 is a plant material. Plant material is a whole plant or part of a plant such as a cell, tissue, leaf, fruit, stem, flower or root.

Preferably, said plant material comes from farms comprising plantations. These plantations are derived from vitro-plant, agriculture, forestry or horticulture such as vegetable, fruit, cereal, oilseed or protein crops.

As non-limiting examples of usable plant material, the following plant families can be mentioned: Amaranthaceae, Apiaceae, Arecaceae, Asteraceae, Brassicaceae, Cannabaceae, Cucurbitaceae, Fabaceae, Liliaceae, Musaceae, Poaceae, Rosaceae, Rubiaceae, Rutaceae, Solanaceae and Vitaceae.

Another example is grass, i.e., any annual or perennial, non-woody plant belonging to the Angiosperms (monocotyledons or dicotyledons), generally green in colour. More specifically, grass commonly refers to the grasses, especially the forage grasses, which make up the grasses, meadows and lawns, and the morphologically related families rushes and sedges.

Preferably, the plant species used are: Allium ampeloprasum var. porrum (Leek), Allium cepa (Onion), Allium sativum (Garlic), Brassica oleracea (Cabbage) including var. italica (Broccoli) and var. botrytis (Cauliflower), Cannabis sativa (Cannabis), Capsicum annuum (Pepper), Cucurbita pepo (Courgette), Cucurbita maxima (Pumpkin), Daucus carota (Carrot), Elaeis guineensis (Oil palm), Fragaria x ananassa (Strawberry), Glycine max (Soya), Helianthus annuus (Sunflower), Hordeum vulgare (Barley), Lactuca sativa (Lettuce), Malus domestica (Apple), Mangifera indica (Mango), Musa spp. (Banana), Nicotiana tabacum (Tobacco), Oryza sativa (Rice), Prunus persica (Peach), Prunus avium (Cherry), Pyrus communis (Pear), Raphanus sativus (Radish), Rosa hybrida (Rose), Secale (Rye), Solanum lycopersicum (Tomato), Solanum tuberosum (Potato), Triticum spp. (Wheat), Vitis vinifera (Vine), Zea mays (Maize).

According to the invention, the device enables one or more light pulses to be emitted from one or more light treatment panels.

These light pulses may be of different wavelength, power and/or duration. Similarly, it is possible to consider superimposing different light pulses (in terms of wavelength, duration or power) during the passage of the device.

In particular, this makes it possible to use different light pulses simultaneously, separately or spread out over time.

The first light pulse emission module 3 of the device according to the invention comprises at least one light treatment panel whose surface is between 0.01 m² and 10 m².

Preferably, the area of the light treatment panel is between 0.01 m² and 5 m². Even more preferably, the surface area of the panel is between 0.01 m² and 3 m². The surface area of the panels preferably used is approximately 0.4 m², 0.8 m², 1 m² or 1.2 m².

According to the invention, the mobile light exposure device 1 for improving the yield and quality of biological material comprises a second adjustment module 6.

The second adjustment module 6 can be controlled remotely or directly on the device.

Preferably, the second adjustment module 6 allows both adjustment of the optical power density of the treatment panel and the temperature of the panel.

The temperature of the panel is regulated actively (e.g. by a fan) or passively (e.g. by a thermal diffuser) by a temperature control unit 12 which changes the temperature based on data it receives from a temperature sensor 13.

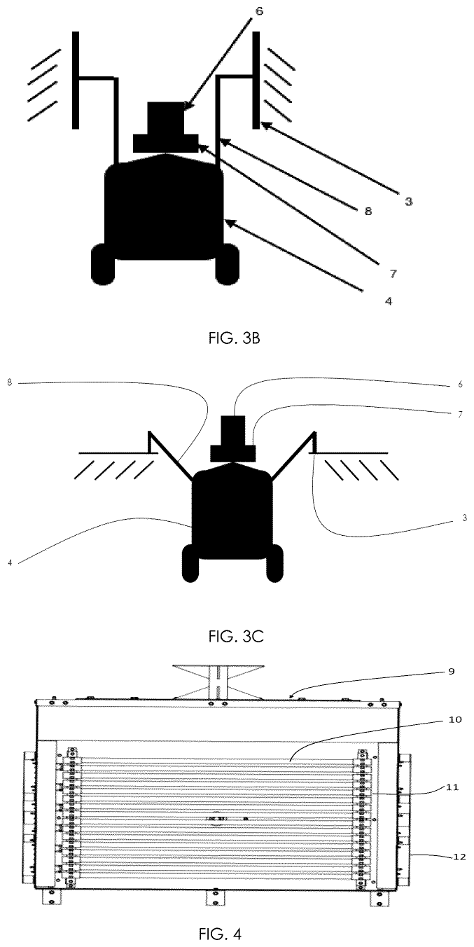

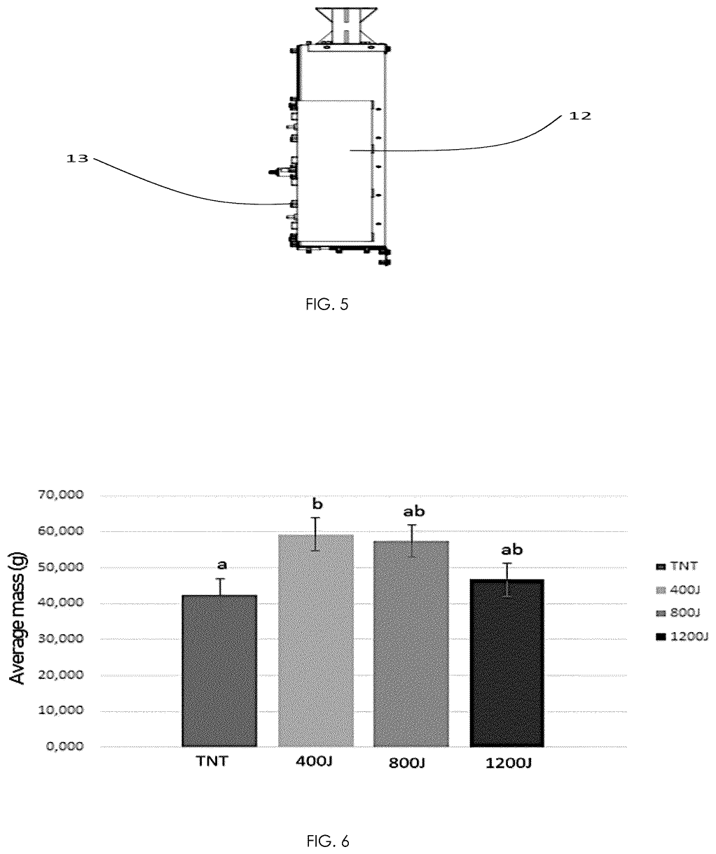

Preferably, the second adjustment module controls a mechanical adjustment module 8 which ensures the correct positioning of the panels with respect to the biological material 2, in particular when the biological material 2 is presented in the form of a low culture as illustrated in FIGS. 3A and 3C.

The optical power density of the panel is between 100 W/m² and 10 000 W/m², preferably between 300 W/m² and 3 000 W/m². The sources used can be discharge lamps (including low, medium or high pressure lamps, pulsed or Xenon light, Excimer lamps) or LEDs. The above-mentioned light sources 10 can be advantageously mounted on a so-called reflector body 9 with reflectors 11 as well as the temperature control unit 12, in order to control the light beam as shown in FIG. 4.

Even more preferably, the optical power density of the panel is between 500 W/m² and 2500 W/m², preferably between 1000 W/m² and 2000 W/m².

Of course, the person skilled in the art will be able to adapt the above-mentioned settings according to the surface and the plant material to be treated.

According to the invention, the mobile light exposure device 1 for improving the yield and quality of biological material 2 also comprises a locomotion means enabling the device 4 to be moved, preferably at a speed of between 1 and 10 km/h. The means of locomotion 4 is advantageously a traction or propulsion means.

Preferably, the speed of the mobile device is between 1 and 10 km/h. Preferably again, it is between 2 and 5 km/h. The particularly preferred speed values used by the Applicant are 4 km/h, 3.6 km/h, 2.5 km/h and 1.8 km/h.

The means of locomotion 4 may or may not include driving wheels that can travel on any type of road or rail. Depending on the nature of the surface, it may refer to a traction device consisting of wheels and assisted or not by motor. Non-limiting examples include but are not limited to:
a wheelbarrow or trolley;
a locomotion device with wheels running on rails, for example in the form of a specialised treatment trolley;
a tractor coupled to a straddle carrier 5 for the largest areas to be treated, or
a storage space with straps to be carried on the back, such as a rucksack.

Preferably, the means of locomotion 4 used is a traction or propulsion device consisting of wheels assisted by a thermal or electric motor.

The size of the areas to be treated is variable and can generally range from 0.001 m² to 100 hectares. Preferably, the surface area of the areas to be treated corresponds to the size of a crop field, a nursery, a green space, but also to a product obtained in post-harvest.

The device according to the invention is advantageously powered by an independent and/or autonomous energy source 7. Preferably, the power source is in the form of a battery and/or an alternator. Alternatively, the device can also be assisted by the presence of solar panels, an electric, combustion, internal combustion or hybrid engine.

Advantageously, the device is powered by a single-phase or three-phase, 50 or 60 Hz alternator delivering a voltage of between 110 V and 500 V. Preferably, this alternator has a voltage stabilisation device and will produce a power at least equal to the power of the lamps. For example, a device with a 2 m² panel will need to be powered by an alternator providing between 250 W and 25,000 W depending on the optical power density selected.

The invention also relates to a process for improving the yield and quality of biological materials comprising the following steps:
installation of a device according to the invention on a farm comprising plantations to be treated;
passage of said device through the plantations combined with direct exposure of the biological material to light pulses of the same or different wavelengths and/or durations, wherein the wavelengths are the same or different and are between 200 nm and 700 nm (UV-C, UV-B, UV-A, visible light), preferably between 200-280 nm (UV-C);
   and wherein the exposure times are the same or different but less than or equal to two seconds, preferably less than or equal to one second.

Preferably, the method according to the invention is adapted to a biological material 2 which is a plant material such as a fruit, vegetable, seed, vitro plant, tuber or any other part of a plant.

Finally, the invention has as a last object the use of a device according to the invention, for the modification of the physiology of a biological material 2.

The light pulses emitted by the use of the invention modify the physiology of the biological material. Modification of the physiology of a biological material 2 means mechanical, physical and/or biochemical modification as a result of its interaction with the environment.

According to a first preferred embodiment, the object of the invention is the use of a device for modifying the primary and/or secondary metabolism of a biological material 2, preferably of a plant material.

Preferably, the effects are observable on the primary and secondary metabolism of plants.

Primary plant metabolism refers to all metabolites directly involved in normal growth, development and reproduction. Secondary metabolism involves all metabolites existing in low concentrations in plants.

Observable effects include a quantitative and qualitative change in the production of chemical molecules produced by the primary and secondary metabolism of plants. By way of non-limiting examples, the molecules concerned may be monosaccharides, glucosinolates, amino acids, proteins, lipids, terpenoids, phenolic compounds, alkaloids or cannabinoids (THC for tetrahydrocannabinol and CBD for cannabidiol).

The Applicant has observed that the process according to the invention allows an increase in the concentration of cannabinoids (THC, CBD), flavonoids and terpenes.

The quantitative and qualitative modification of the production of chemical molecules produced by the primary and secondary metabolism of plants can lead to the modification of the growth and/or development, the increase of the defences as well as the morphogenesis of a biological material 2, preferably of a plant material, especially under stress.

According to a second preferred embodiment, the object of the invention is the use of a device for modifying the growth and/or development of a biological material 2, preferably of a plant material.

According to a third preferred embodiment, the invention relates to the use of a device for increasing the defences of a biological material 2, preferably a plant material.

Surprisingly, the Applicant was also able to demonstrate that the use of the device according to the invention and in particular the application of light pulses to the biological material 2 made it possible to obtain the following effects:
tallage induction, particularly in Poaceae;
acceleration of the plant development cycle, particularly for strawberry plants;
lifting of dormancy;
increase of the plant's defences;
decontamination of plants;
induction of fruit earliness, especially for strawberries;
improvement of flower initiation, especially in soybeans, and oilseed crops such as rapeseed or sunflower, and of crop growth and yield, especially when applied at particular stages, such as the grain filling stage in wheat;
application at early stages reduces the risk of lodging and improves yield by promoting root development and anchorage in wheat;
application at early stages reduces the risk of lodging and improves yield by shortening internodes and strengthening stems, as in wheat, oilseed rape and sunflower;
application during growth allows the control of plant growth by reducing or stimulating it, depending on the dose, as in the case of grass;
application at particular stages, especially near and after harvest, can improve the quality of many crops such as medicinal hemp, tomato, apple and strawberry, by stimulating or modifying the production of secondary compounds (phenolic compounds, terpenoids, alkaloids, cannabinoids, glucosinolates . . . );
improving the quality of plant production by stimulating or modifying primary or secondary metabolism resulting in the production of flavours, fragrances, colour pigments and phytomicronutrients. But also starch and protein in potatoes and cereals such as wheat, lipids in oilseed crops such as sunflower and rapeseed, protein in protein crops such as soybeans, fibre in industrial crops such as hemp, sugars and organic acids in fruit crops such as apples, and compounds used for the production of biofuels such as in rapeseed and sunflower;

Thus, the results obtained by using this invention may also be applicable in the following fields, as non-limiting examples: pharmacology, cosmetics, the paper industry and its derivatives, the flavour and perfume industry, the “green” chemical industry, the food industry, animal feed, nutraceuticals.

The present invention will now be illustrated by means of the following examples.

### Examples

The first results obtained with mercury vapour lamps (254 nm) show a superiority of UV-C flashes (one second) compared to conventional exposures (one minute). UV-C flashes show stimulating effects on secondary metabolism, growth, yield and production quality.

Example 1: Effects of UV-C flashes on secondary tobacco metabolism.

The tobacco plants were sown at D0.

Observations were made on the effects of UV-C treatments applied at a dose of 1 kJ/m², either as one second flashes (D1) or as conventional one minute exposures (D2), on the nicotine concentration of tobacco leaves from plants grown in pots under glass. The trial also included an untreated control.

The device used for the UV-C treatments consisted of mercury vapour lamps (254 nm) and allowed comparison of flashes and conventional exposures at the same dose and wavelength.

Several UV-C treatments were carried out, namely at D47, D54 and D61 and at D68. Harvesting took place one week later at D75.

Two basal leaves were collected per plant, from ten plants per sample. That is a total of 20 leaves collected per sample. n=3. The leaves were oven-dried at about 80° C. for 48 hours and then ground.

Nicotine was determined by HPLC-DAD 260 nm and the concentration expressed on a dry matter basis.

Tab. 1. Effect of conventional and UV-C flash exposures on nicotine concentration in tobacco leaves. Different letters indicate significant differences at the 5% level.

TABLE 1

| | Nicotine content expressed |
|---|---|
| | as % of dry matter |
| Control | 0.385 + 0.008 b |
| Flashes | 0.452 + 0.037 c |
| Conventional | 0.353 + 0.005 a |
| Exposures | |

### Conclusion:

The results in Table 1 show that UV-C flashes substantially increase (+17%) the nicotine concentration of tobacco leaves compared to the control, while conventional exposures decrease it (−8%).

Example 2: Effects of different doses of UV-C flashes on leek growth, yield and quality.

The leek plants were sown at D0.

Observations were made on the effects of UV-C flash treatments applied at three doses, 400, 800 and 1200 J/m² on the mass and length of the drums. The trial also included an untreated control (UT). The scheme was completely randomised with n=11.

The device used for UV-C treatments consists of mercury vapour lamps (254 nm). Doses of 400, 800 and 1200 J/m² were obtained with exposure times of 1 s, 2 s and 3 s, respectively.

Four treatments were performed, every 7 days, between D23 and D44.

The drums were harvested at D51, weighed and measured for length.

### Conclusion:

The results in FIG. 6 show that the treatments increased growth and therefore yield as there was an increase in the harvest weight of the barrels as a result of the treatments. Remarkably, the strongest effect was observed with the 400 J/m² treatment obtained in 1 s.

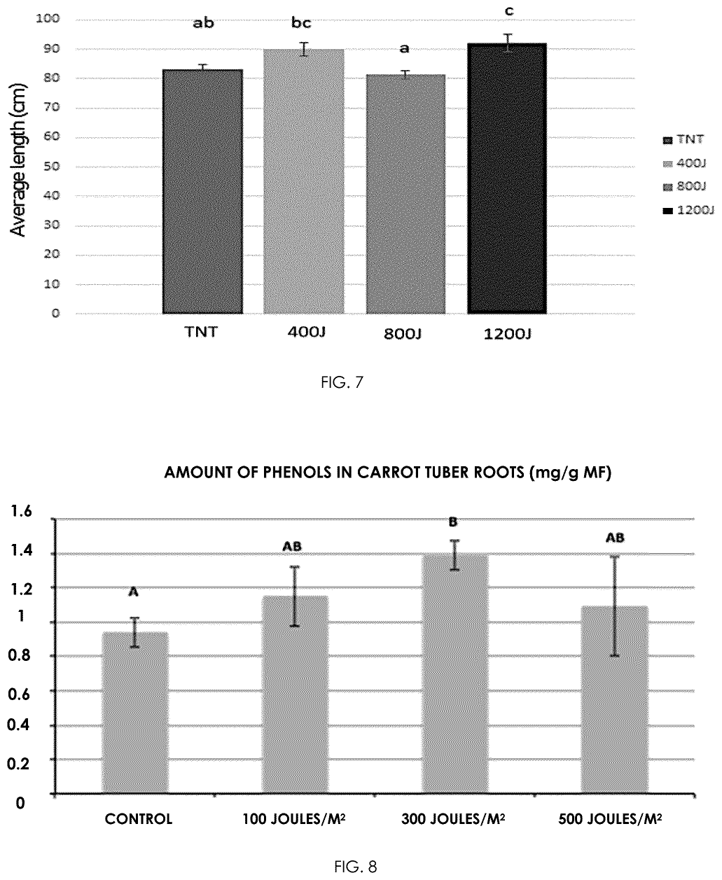

From the results in FIG. 7, it can be concluded that a morphogenetic effect and thus on the “presentation quality” (length to mass ratio) was also observed. The increase in mass is not entirely attributable to the increase in length. The increase in barrel length is significantly greater for the 1200 J/m² treatment.

Example 3: Effects of UV-C flashes on carrot growth and development.

The red anthocyanin variety GNIFF AB from the Sainte Marthe farm was used in this trial.

Sowing took place at D0 and cultivation was carried out in a greenhouse with temperatures between 17° C. and 26° C.

The device used for the UV-C treatments consisted of mercury vapour lamps (254 nm). The doses of 100, 300 and 500 J/m² were all obtained with an exposure time of one second by adjusting the distance between the lamps and the plants. The experimental set-up also included a control n=35.

The carrots were harvested at D60. The total weight, length and diameter of the roots were measured. The length of the leaves was also measured.

Tab. 2. Effect of different doses of UV-C applied as one second flashes on leaf length, total weight, length, diameter and length to diameter ratio of carrot roots. *, ** and *** correspond to differences with the control, significant at the 10%, 5% and 1% thresholds, respectively (Student's t test).

TABLE 2

| | Leaf length | Total Weight | Root Length | Root Diameter | Length/diameter |
|---|---|---|---|---|---|
| Treatment | (cm) | (g) | (cm) | (mm) | ratio |
| Control | 25.1 + 0.5 | 7.9 + 0.3 | 5.1 + 0.1 | 13.5 + 0.4 | 3.9 + 0.2 |
| 100 J/m² | 27.9 ± 0.7*** | 9.7 ± 0 4*** | 5.5 ± 0.1* | 14.9 ± 0.5** | 3.8 ± 0.1 |
| 300 J/m² | 26.7 ± 0.6*** | 10.6 ± 0.5*** | 5.3 ± 0.1 | 16.2 ± 0.5*** | 3.4 ± 0.1* |
| 500 J/m² | 28.9 ± 0.5*** | 12.5 ± 0.6*** | 5.0 ± 0.2 | 17.0 ± 0.5*** | 3.0 ± 0.1*** |

### Conclusion:

UV-C flashes applied during cultivation increase leaf length and total weight and root diameter. Only the 100 J/m² treatment increases the root length. It can be seen that UV-C flashes stimulate growth and yield. They can also exert morphogenetic effects and therefore on the quality of presentation by modifying the length/diameter ratio of the roots (treatments at 300 and 500 J/m²). In general, the effects on leaf length, total weight and root diameter are more pronounced the higher the applied rate.

Example 4: Effects of UV-C flashes on the quantity of phenols, flavonoids and on the anti-free radical activity of carrots.

The red anthocyanin variety GNIFF AB from the Sainte Marthe farm was used in this trial.

Sowing took place at D0 and cultivation was carried out in a greenhouse with temperatures between 17° C. and 26° C.

The device used for the UV-C treatments consisted of mercury vapour lamps (254 nm). The doses of 100, 300 and 500 J/m² were all obtained with an exposure time of one second by adjusting the distance between the lamps and the plants. The experimental set-up also included a control n=b 35.

The root tubers of the carrots were harvested at D60 and ground in liquid nitrogen and the powder was used for the determination of phenolic compounds, flavonoids and all anti-free radical species.

### Conclusion:

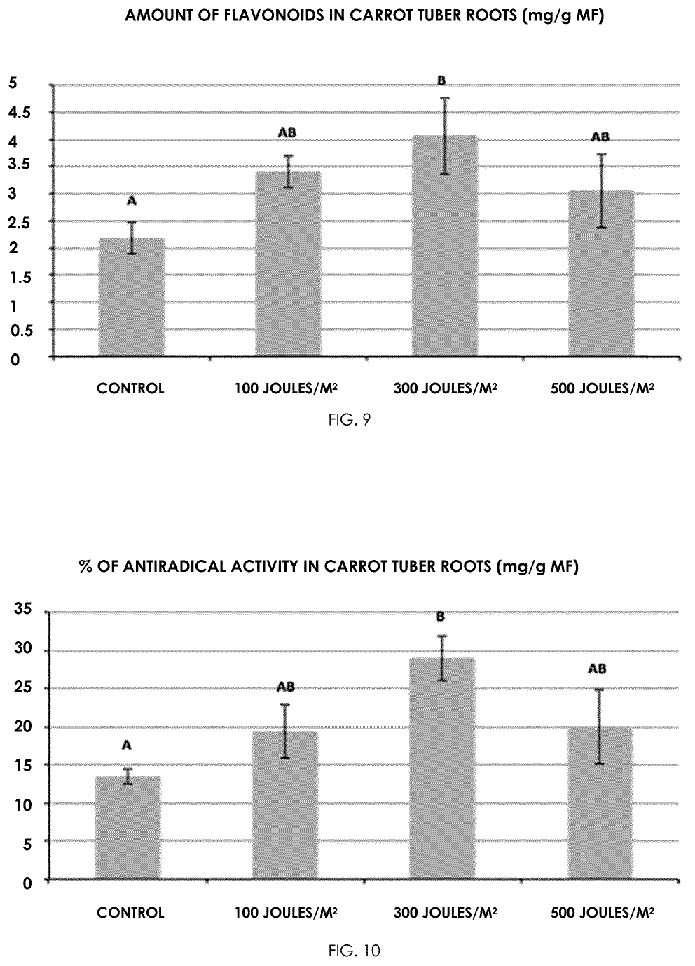

UV-C flashes applied during cultivation increase the amount of phenols (FIG. 8) and flavonoids (FIG. 9) and increase the anti-radical activity (FIG. 10) of carrot root tubers. These increases are significantly marked with the 300 J/m² dose.

Example 5: Effects of UV-C flashes on floral development and flowering uniformity in strawberry.

Refrigerated strawberry plants of the variety ‘Gariguette’ were planted in 2 litre pots in a glasshouse at D0.

The device used for UV-C treatments consists of mercury vapour lamps (254 nm). The treatments consisted of applying a dose of 800 J/m² (in 1 s) on the following days: D5, D12, D19 and D26. The treatments were carried out on normal plants and on plants treated with a defence elicitor treatment (Vacciplant®). Vacciplant® treatments were carried out at D10 and D24. In addition to normal plants treated with UV-C and plants treated with UV-C and Vacciplant®, the randomised trial included untreated plants and plants treated only with Vacciplant® n=20.

Flowering was noted on the following days: J10, J12, J14 since the start of the test, noted as JO, J+2, J+4 in the figure).

### Conclusion:

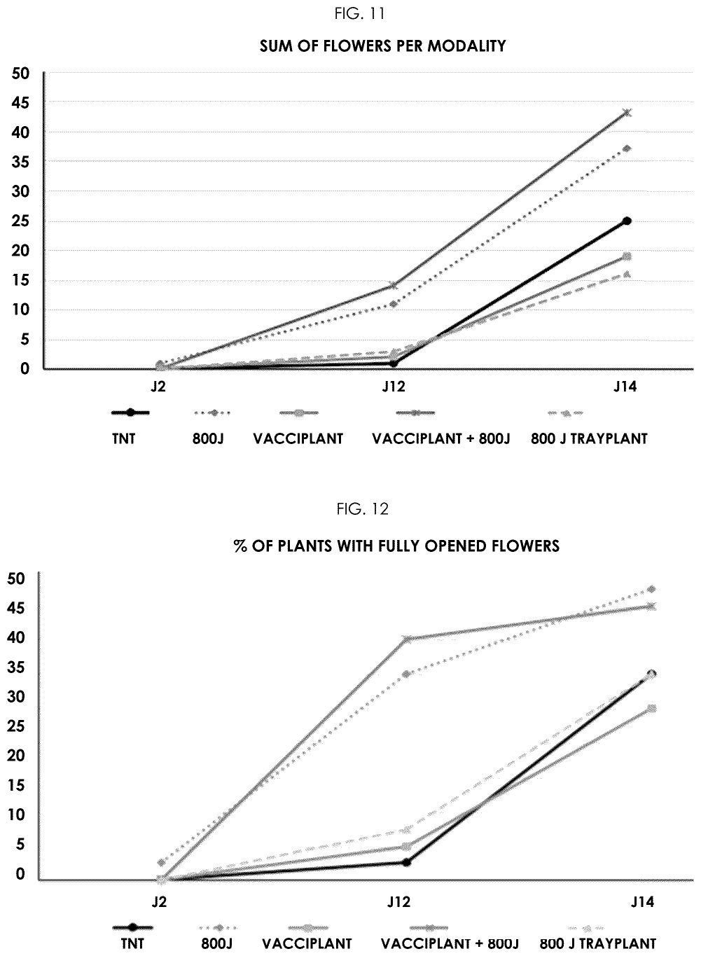

FIGS. 11 and 12 show that the UV-C flash treatments had a stimulating effect on the development of the strawberry plant, i.e. accelerating floral development, as seen up to D+4 (D14). The effect of accelerated flower development was seen in both Vacciplant® treated and untreated plants. Remarkably, the UV-C flash treatments were able to counteract the negative effect of Vacciplant® on the flowering rate of strawberry.

Example 6: Effects of UV-C flashes on the start of strawberry production.

Strawberry plants of the variety ‘Gariguette’ were planted in 21 pots under glass at D0.

The device used for the UV-C treatments consisted of mercury vapour lamps (254 nm). Observations were made on the effects of two UV-C doses (D1=800 J/m², D2=1600/m²), obtained after 1 and 2 s of exposure respectively. The UV-C treatments were carried out on the following days: J18, J25, J32 and J45. The trial included a control (TNT) and n=20.

Observations were made at D53 on the number of flowers, the number of green fruits and the number of ripe fruits.

### Conclusion:

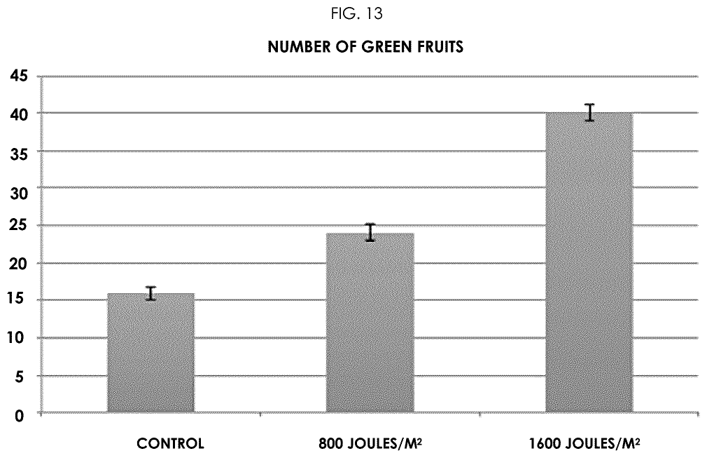

At D53, there was no difference in the number of flowers between the treated plants and the control (results not shown), which is consistent with the end of trial observations presented in Example 4. FIG. 13 shows that the number of green fruits was 50% higher in treatment D1 (800 J/m²) and more than 150% higher in treatment D2 (1600 J/m²) compared to the untreated control. At D53, 8 ripe fruits were also observed in the D2 treatment alone (1600 J/m²) (results not shown). These results show that it is possible to increase early production with UV-C treatments and that the dose influences the result.

Example 7: Effects of UV-C flashes on cannabinoid production in Cannabis sativa L.

Several Cannabis sativa L. plants were planted at D0 in Spain, in 15 L pots filled with fertilised All Mix potting soil, in Mylar ‘Black boxes’. Watering was provided every 3 days. The imposed temperatures were 19° C. at night and 26° C. during the day. During the growth phase (3 weeks), the photoperiod was 18 h day/6 h night with lighting provided by MH 250W 6600° K lamps. During the flowering phase (8 weeks), the photoperiod was 12 h day/12 h night with lighting provided by HPS 400W 2700° K lamps. Ventilation was provided with a flow rate of 15 m3/h.

The device used for the UV-C treatments consisted of mercury vapour lamps (254 nm). Observations were made on the effects of a single dose of UV-C given as a one second flash, first from the 5th week of flowering, and a second time one week later.

Samples were taken one week after the second light treatment from pooled plant material per treatment (2 grams per treatment). The comparison focused on the effect of UV-C flash treatments versus an untreated control.

Tab. 3. Effect of UV-C flash exposures on cannabinoid concentration in Cannabis sativa L. inflorescences expressed as mg/g dry matter.

TABLE 3

| | Control | UV-C flashes |
|---|---|---|
| CBD | 1.35 | 0.99 |
| THC | 6.52 | 47.06 |

### Conclusion:

The results in Table 3 show that UV-C flashes substantially increase (+621%) the THC concentration compared to the control. CBD levels are only trace, as expected.

Example 8: Effect of UV-C flashes on vine yield

The trial was conducted on vines located on a ‘Merlot’ plot randomised in 3 blocks. Plants treated with UV-C flashes were exposed to illuminations of about one second every 10 days from April to July. The lamps used for the light treatments were UV-C (254 nm) amalgam lamps mounted on a prototype tractor moving between the crop rows. The treatments consisted of flashes of approximately one second, delivering 800 J/m²/flash.

10-13 randomly selected plants were harvested individually per block (n=35) in September. The values in the table are averages+standard deviations, expressed in kg of clusters per vine. Different letters indicate significant differences at the 5% level (non-parametric Kruskal Wallis test).

TABLE 4

| | Yield |
|---|---|
| Treatments | (kg berries + stalks/foot) |
| Control | 1.790 ± 0.755 a |
| UV-C flashes | 2.242 ± 0.728 b |

1. An apparatus comprising:
a locomotion device and having a reflector body extending therefrom to which is mounted a UV-C light source operatively positioned relative to a reflector and operatively temperature controlled by an on-board temperature control unit to form a panel;
wherein the UV-C light source is operatively controlled to administer a dose of UV-C light based on a duration of exposure of at most two seconds;
wherein the panel has an optical power density between 300 W/m² and 3000 W/m² and a surface area of 0.01 m² to 5 m², and the panel is configured to administer the dose in a range of 100 J/m² to 1600 J/m² as the locomotion device moves at an operating speed in a range of 1 km/hr to 10 km/hour.

2. The apparatus of claim 1, wherein the locomotion device is a wheeled locomotion device.

3. The apparatus of claim 1, wherein the locomotion device runs on rails.

4. The apparatus of claim 1, wherein the locomotion device is a tractor, wheelbarrow, or trolley.

5. The apparatus of claim 1, the locomotion device comprises a thermal or electric motor.

6. The apparatus of claim 1, wherein the locomotion device comprises an on-board energy source selected from the group consisting of a battery, alternator, solar panels, electric engine, combustion engine, internal combustion engine, hybrid engine, or a combination thereof.

7. The apparatus of claim 1, wherein the locomotion device has an autonomous energy source.

8. The apparatus of claim 1, wherein the UV-C light source comprises a plurality of discharge lamps or light emitting diodes and is configured to emit light simultaneously or sequentially of different (i) optical power density, (ii) time duration, or (iii) wavelength.

9. The apparatus of claim 8, wherein the optical power density of the panel is adjustable.

10. The apparatus of claim 9, wherein the optical power density is adjustable to be in a range of 500 W/m² to 2500 W/m².

11. An apparatus comprising:
a storage space with straps configured to be carried on a user's back and having a reflector body extending therefrom to which is mounted a UV-C light source operatively positioned relative to a reflector and operatively temperature controlled by an on-board temperature control unit;
wherein the UV-C light source is operatively controlled to administer a dose of UV-C light based on a duration of at most two seconds;
wherein the panel has an optical power density between 300 W/m² and 3000 W/m² and a surface area of 0.01 m² to 5 m², and the panel is configured to administer the dose in a range of 100 J/m² to 1600 J/m² as the user moves at an operating speed in a range of 1 km/hr to 5 km/hour.

12. The apparatus of claim 11, wherein the storage space comprises an autonomous energy source.

13. The apparatus of claim 11, wherein the UV-C light source comprises a plurality of discharge lamps or light emitting diodes and is configured to emit light simultaneously or sequentially of different (i) optical power density, (ii) time duration, or (iii) wavelength.

14. The apparatus of claim 13, wherein the optical power density of the panel is adjustable.

15. The apparatus of claim 14, wherein the optical power density is adjustable to be in a range of 500 W/m² to 2500 W/m².

16. An apparatus comprising:
a trolley or wheelbarrow having a reflector body extending therefrom to which is mounted a UV-C light source operatively positioned relative to a reflector and operatively temperature controlled by an on-board temperature control unit;
wherein the UV-C light source is operatively controlled to administer a dose of UV-C light based on a duration of at most two seconds;
wherein the panel has an optical power density between 300 W/m² and 3000 W/m² and a surface area of 0.01 m² to 5 m², and the panel is configured to administer the dose in a range of 100 J/m² to 1600 J/m² as the trolley or wheelbarrow moves at an operating speed in a range of 1 km/hr to 5 km/hour.

17. The apparatus of claim 16, wherein the trolley or wheelbarrow comprises an autonomous energy source and is configured for operation within a greenhouse.

18. The apparatus of claim 16, wherein the UV-C light source comprises a plurality of discharge lamps or light emitting diodes and is configured to emit light simultaneously or sequentially of different (i) optical power density, (ii) time duration, or (iii) wavelength.

19. The apparatus of claim 18, wherein the optical power density of the panel is adjustable.

20. The apparatus of claim 19, wherein the optical power density is adjustable to be in a range of 500 W/m² to 2500 W/m².
